(19) United States
(12) Patent Application Publication
(10) Pub. No.: US 2024/0366054 A1
(43) Pub. Date: Nov. 7, 2024

(54) Easybroom

(71) Applicant: Olive Peart, Aspen Hill, MD (US)

(72) Inventor: Olive Peart, Aspen Hill, MD (US)

(21) Appl. No.: 18/310,318

(22) Filed: May 1, 2023

(51) Int. Cl. A47L 13/16; A47L 13/42

(52) U.S. Cl. CPC A47L 13/16; A47L 13/42; B25G 1/04

(57) ABSTRACT

EasyBroom is a wedge attachment designed to sweep and clean all types of indoor smooth or semi-smooth flooring surfaces such as hardwood, laminate, tile, vinyl, concrete and more. This is a lightweight device with durable construction that attaches to a telescopic swivel handle. The handle would extend from 36 to 60 inches. The swivel handle allows versatility and easily reaches under couches or between furniture. The broom cover or pad grabs dust, pet hairs and dirt from flooring or furniture. With EasyBroom, cleaning up is easy. The broom pad or cover can be replace and discarded after use or washed and re-used.

EasyBroom is a wedge attachment designed to sweep and clean all types of indoor smooth or semi-smooth flooring surfaces such as hardwood, laminate, tile, vinyl, concrete and more. This is a lightweight device with durable construction that attaches to a telescopic swivel handle. The weight is approximately 141.78 grams. The handle would extend from 36 to 60 inches. The swivel handle allows versatility and easily reaches under couches or between furniture.

The core of the EasyBroom is used with a cover or pad that grabs dust, pet hairs and dirt from flooring or furniture. A cover can fully enclose the EasyBroom or a pad can be attached with a Velcro like method. The pad or cover covers the cleaning surface of the EasyBroom. The broom handle, cover and pad can be sold separately.

With EasyBroom, cleaning up is easy. The broom pad or cover can be replace and discarded after use or washed and re-used. The cover can be made with cotton or flannel or other highly absorbent material that will not scratch the flooring or furniture.

### BACKGROUND OF INVENTION

Olive Peart received help with the design of the EasyBoom from Davison Inventing.

### BRIEF DESCRIPTION OF DRAWING

FIG. 1: EasyBroom. Shows all the attachments of the EasyBroom, including the handle which can attach to the swivel support portion of the EasyBoom.

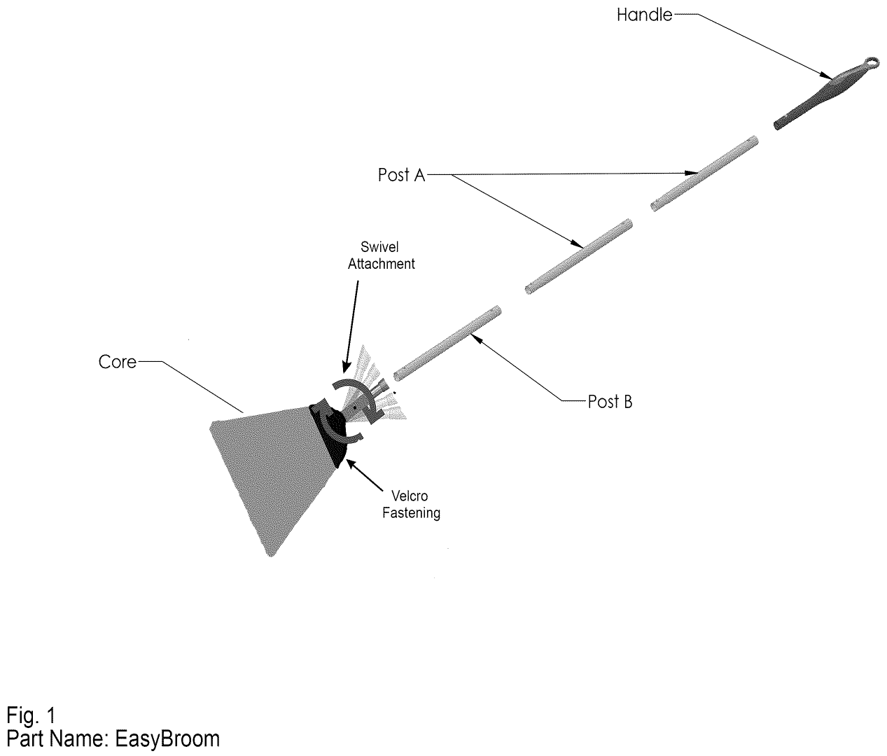

FIG. 1A: This shows the swivel attachment.

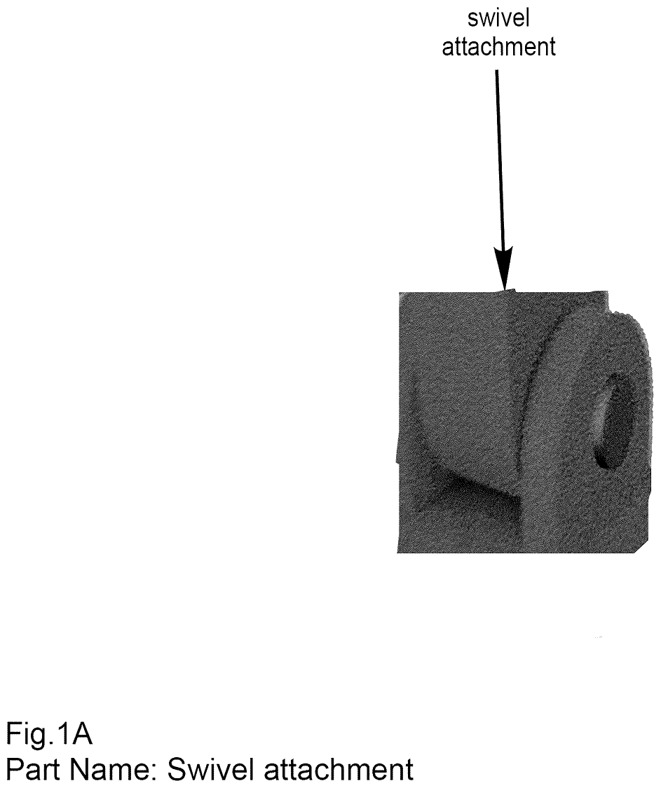

FIG. 1B: This shows the velco fastening method of attaching the cleaning pad to the Core/Head of the EasyBroom.

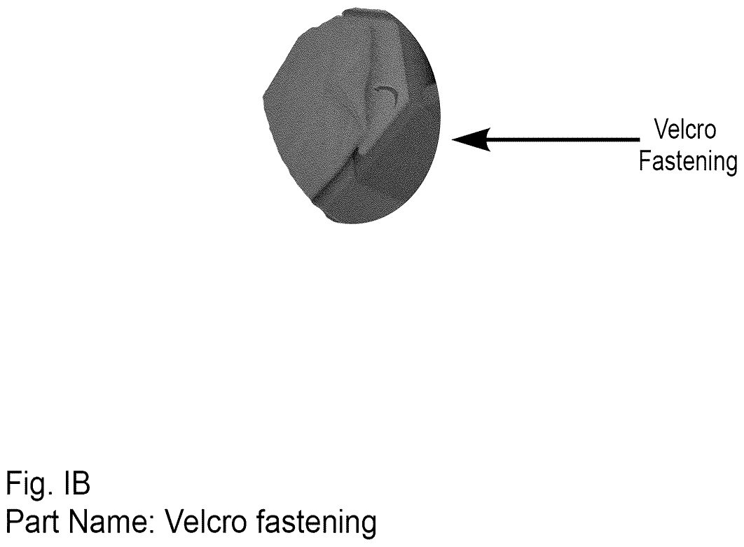

FIG. 2: EasyBroom Core/Head. Shows the actual EasyBroom device which is the broom head. It is made of plastic and includes the swivel attachment which connects to the broom handle.

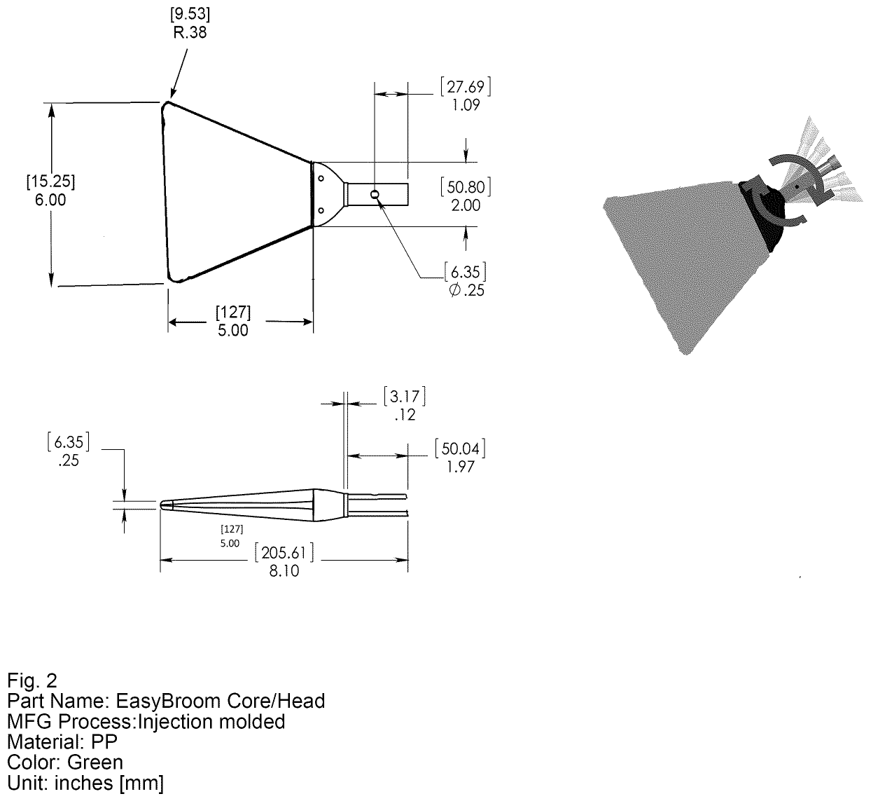

FIG. 3. EasyBroom Pad. The shows the cleaning pad. This item can be sold separately and can be attached to the EasyBroom Core/Head with Velcro.

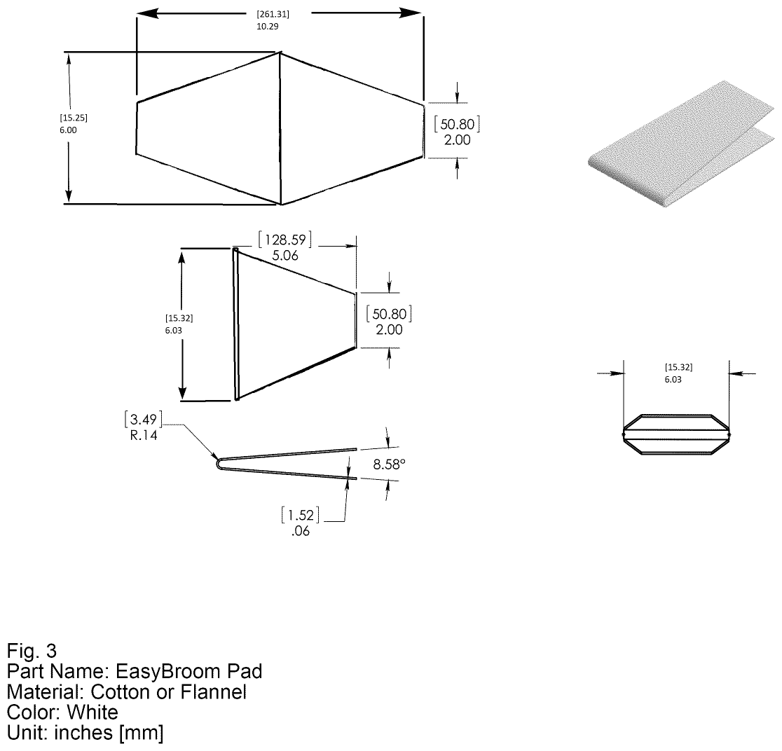

### ABSTRACT OF THE DISCLOSURE

EasyBroom is a wedge attachment designed to sweep and clean all types of indoor smooth or semi-smooth flooring surfaces such as hardwood, laminate, tile, vinyl, concrete and more. This is a lightweight device with durable construction that attaches to a telescopic swivel handle. The handle would extend from 36 to 60 inches. The swivel handle allows versatility and easily reaches under couches or between furniture. The broom cover or pad grabs dust, pet hairs and dirt from flooring or furniture. With EasyBroom, cleaning up is easy. The broom pad or cover can be replace and discarded after use or washed and re-used.

1. Do you have dusty surfaces or floor that needs cleaning? Dust and dirt can often be hard to reach. EASYBROOM is a new wedge dusting and cleaning attachment that will help you get the job done! It can be used to reach under couches, between furniture, and more. The wedge shape is great for reaching nooks and crannies. It can be used with disposable cloths or cleaning cover can be replaced as needed.
